(19) United States
(12) Patent Application Publication
(10) Pub. No.: US 2004/0128418 A1
(43) Pub. Date: Jul. 1, 2004

(54) Mechanism and apparatus for SMI generation

(76) Inventors: Darren Abramson, Folsom, CA (US); Michael Derr, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/334,242

(22) Filed: Dec. 30, 2002

(51) Int. Cl. G06F 13/24

(52) U.S. Cl. 710/260

(57) ABSTRACT

An apparatus includes an interrupt stimulus matching circuitry, including interrupt matching registers, to receive incoming cycles. The interrupt stimulus matching circuitry detects stimulus conditions associated with the incoming cycles that match desired interrupt conditions. A control device generates an interrupt in response to a stimulus condition matching an interrupt stimulus condition. The interrupt stimulus matching registers store interrupt stimulus conditions.

### BACKGROUND

Conventionally, when a defect, such as a deviation between hardware behavior and specified behavior, is detected in hardware, one of a number of approaches is taken. One approach is to de-feature the functionality if possible. This approach reduces the value of the product and is unacceptable in many cases. Another approach is to work-around the problem through software settings if possible. In this approach, the BIOS modifies the hardware behavior as the system boots to avoid the problem in the future. However, the software settings that are available to software today tend to be very specific and, therefore, typically not useful for complex defects in highly integrated silicon. A further approach is to work-around the problem through modified software algorithms if possible. This approach can impact performance greatly and is not available in many situations. For example, this approach is not available to legacy software where operating systems and drivers are involved and to newer processors and security initiatives that restrict the use of system management interrupt (SMI) based software work-arounds. The hardware can also be stepped to fix the problem. This approach, however, tends to be very expensive and requires long throughput to make the fix available.

In particular, personal computer systems typically implement a SMI. A SMI signal is asserted to a processor to alert the processor that a SMI event has occurred. The SMI signal is typically asserted to the processor by a system logic device that includes a memory controller. The system logic device may assert the SMI signal for any of a large number of possible reasons. For example, the SMI signal may be asserted if a system resource seeks access to a certain range of memory or to a particular input/output address. Many existing chipsets however rely on PCI decode for most SMI generation capability. SMI is generated based upon fixed cycle decodes but additionally claims the transaction and does not forward the cycle to its destination.

### BRIEF DESCRIPTION OF THE FIGURES

FIG. 1 is a diagram of an embodiment of a patch device.

FIG. 2(a) illustrates a diagram of an exemplary system implementing one embodiment of patch device.

FIG. 2(b) illustrates one embodiment of the system shown in FIG. 2(a).

FIG. 3 illustrates a diagram of an embodiment of an implementation of patch device including SMI generation.

FIG. 4 is a flow diagram of an embodiment of a routine for detecting and altering selected trigger conditions.

FIG. 5 is a flow diagram of an embodiment of a routine for generating interrupts.

### DETAILED DESCRIPTION

An apparatus includes an interrupt stimulus matching circuitry, including interrupt matching registers, to receive incoming cycles. The interrupt stimulus matching circuitry detects stimulus conditions associated with the incoming cycles that match desired interrupt conditions. A control device generates an interrupt in response to a stimulus condition matching an interrupt stimulus condition. The interrupt stimulus matching registers store interrupt stimulus conditions.

In the detailed description, numerous specific details are set forth in order to provide a thorough understanding of the present invention. One skilled in the relevant art will recognize, however, that the invention can be practiced without one or more of the specific details, or with other methods, components, etc. In other instances, well-known structures or requests are not shown or described in detail to avoid obscuring aspects of various embodiments of the invention.

Some portions of the detailed description that follow are presented in terms of algorithms and symbolic representations of operations on data bits or binary signals within a computer. These algorithmic descriptions and representations are the means used by those skilled in the data processing arts to convey the substance of their work to others skilled in the art. An algorithm is here, and generally, considered to be a self-consistent sequence of steps leading to a desired result. The steps include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities. Unless specifically stated otherwise as apparent from the following discussions, it is appreciated that throughout the specification, discussions utilizing such terms as “processing” or “computing” or “calculating” or “determining” or the like, refer to the action and processes of a computer or computing system, or similar electronic computing device, that manipulate and transform data represented as physical (electronic) quantities within the computing system's registers and/or memories into other data similarly represented as physical quantities within the computing system's memories, registers or other such information storage, transmission or display devices.

Embodiments of the present invention may be implemented in hardware or software, or a combination of both. However, embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a micro-controller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

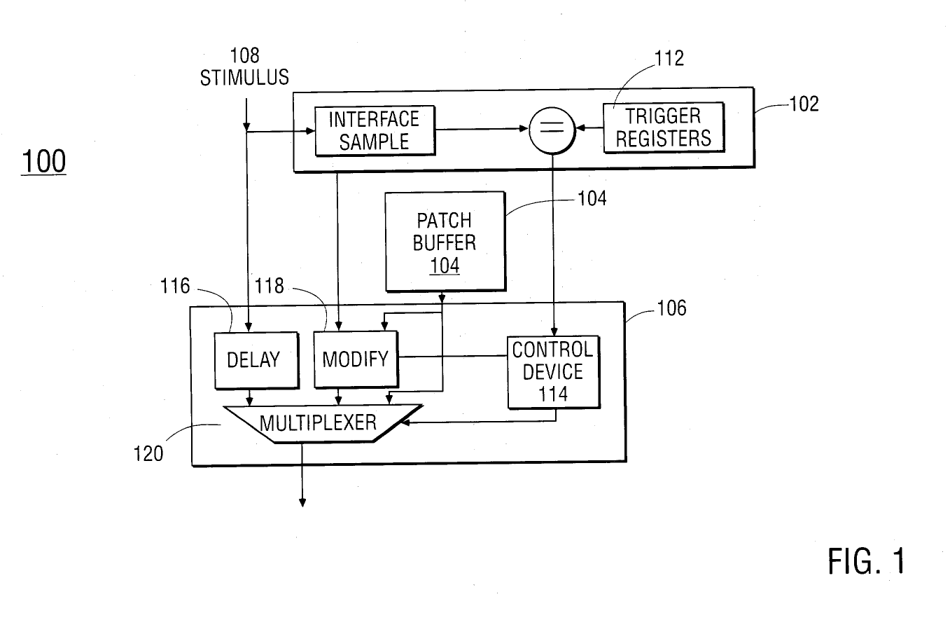

FIG. 1 is a diagram of an embodiment 100 of patch device. Patch device 100 includes trigger-matching logic 102, patch buffer circuit 104 and control logic 106. Input stimulus 108, such as incoming cycles, is provided to patch device 100. In a typical implementation, host interface unit (not shown) provides the stimulus to patch device 100. Trigger-matching logic 102 samples incoming cycles 110 and compares them with information stored in trigger registers 112.

Patch device 100 may be implemented with a wide variety of trigger events, including, but not limited to, power management functions and accesses to particular regions of memory. The term “trigger event” as used herein is meant to include a broad range of computer system activities that computer system designers may wish to implement as activities that trigger the execution of patch device 100. In one implementation, if it is desired to trigger on the presence of a read cycle, trigger registers 112 are programmed to distinguish between read and write cycles and provide a trigger signal upon detection of a read. In other implementations, trigger registers 112 are programmed to trigger on certain address ranges, specific byte addresses or I/O space versus configuration space versus memory space signals. One skilled in the art will recognize that the present invention is not limited to identifying any particular type of signal.

Trigger registers 112 may reside in the chipset, in addition to the other registers programmed in the chipset. Once trigger-matching logic 102 detects a stimulus condition that matches the desired trigger condition, trigger-matching logic 102 notifies control unit 106. If trigger-matching logic 102 indicates that the cycle presented matches a trigger register bit, processing path is taken to control logic 106. If, however, the stimulus condition does not match a trigger register, the processing path is taken to delay stage 116 and mux 120 to the rest of the chip. One skilled in the art will recognize that the delay stage is not required for this invention but represents one embodiment.

Control logic 106 includes control device 114, delay stage 116, modify logic 118 and multiplexer 120. Control logic 106 comprises circuitry for communicating with patch buffer 104, modify logic 118 and multiplexer 120. It will be apparent to those of ordinary skill in the art that the partitioning of components illustrated in FIG. 1 is a logical partitioning. The functionality described below for control logic 106 may alternatively be incorporated into trigger-matching logic 102 or other logic. This logic may be implemented as a gate array, custom integrated hardware or microcode embodiment. It will be apparent to one of ordinary skill in the art that the logic may be implemented using conventional techniques. Control device 114 receives the information from trigger-matching logic 102 and determines whether to delay, modify or replace the chip stimulus cycles.

Patch buffer 104 is a first-in-first-out buffer memory that stores alternate cycles that can be inserted in place of the cycles that triggered control logic 106. The output data is read from patch buffer 104 through the data path when the control signal to multiplexer 120 is enabled. The cycle 108 that triggered the control logic 106 is thus held off from going any further. In a typical implementation, cycle 108 is potentially causing an error in the system, or there is a desire to work around something cycle 108 is going to do.

Multiplexer 120 selects the data to be sent to the rest of the chip based upon the control device 114. In the event there is a trigger, multiplexer 120 flips away from delay stage input so that the incoming cycle is not transmitted to the rest of the chip. For example, multiplexer 120 can select the data read from patch buffer104, modify logic 118 or delay stage 116. When the control device 114 selects the output to be patch buffer alternate cycles, the incoming cycles 108 are replaced with the new cycles provided by the patch buffer 104.

Patch device 100 can also modify the incoming cycle 108 that is sampled. For example, if the trigger-matching logic 102 detects an error condition, such as an incorrect address to a register, patch buffer 104 could modify the address associated with the cycle and route it to a different location. For example, if the address was byte 02, and the register is implemented in 04, all of the other information about that cycle is taken from that interface sample. If there is a write that is going to location 02, the write data is kept and forwarded to the modify logic 118 to modify the address. Parts of the original cycle can be used while other parts are modified.

In another example, defects can arise if the sequence of events associated with the incoming cycles is not optimized. Patch device 104 can optimize the sequence of events via modify logic 118. Incoming cycles 108 that do not cause a trigger are routed to the delay stage 116. Delay stage 116 can be used to delay incoming cycles 108. Patch buffer 104 can also insert a delay in the instruction stream and then run the original cycle or new cycles in patch buffer 104 as well. The patch sequence may also offer the programming option to generate interrupts such as SMI.

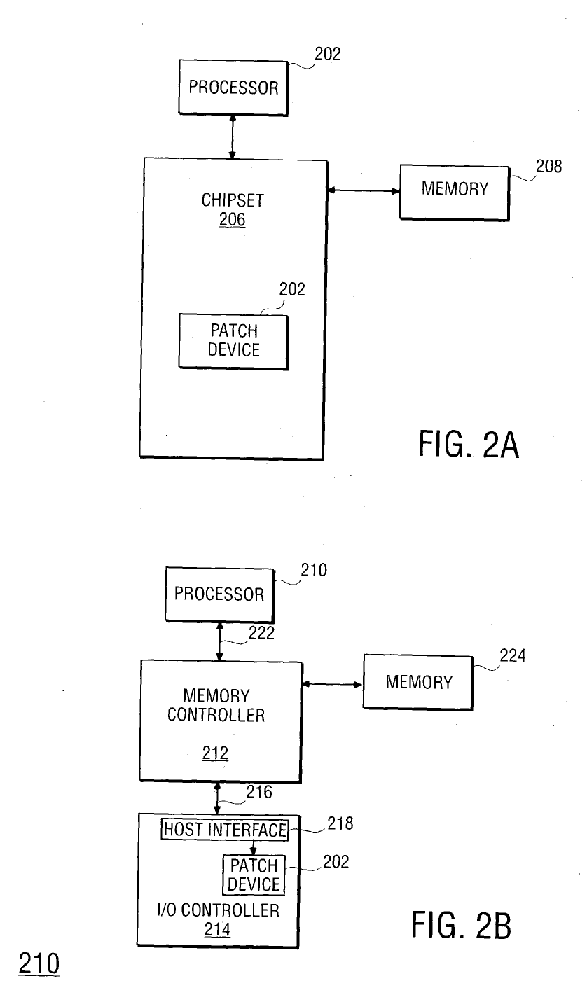

FIG. 2(a) illustrates a diagram of an exemplary system 200 implementing one embodiment of patch device 202. The system includes processor 204 and chipset 206. The system also includes memory 208 that is also coupled to chipset 206. Chipset 206 includes patch device 202. As noted above, trigger-matching logic samples incoming cycles and compares them with information stored in trigger registers.

FIG. 2(b) illustrates an exemplary embodiment 210 of the system shown in FIG. 2(a). System includes processor 210, memory controller 212 and I/O controller 214. The system also includes memory 224 that is also coupled to memory controller 212. Memory controller 212 and I/O controller 214 may be coupled via bus 216. I/O controller 214 may be any device that connects devices to an internal computer system bus, such as, for example, a PCI bus. I/O controller 214 includes host interface unit 218 that facilitates communication with processor 210. Processor 210 communicates with memory controller 212 via bus 222. Host interface unit 218 provides the stimulus to patch device 202. As noted above, trigger-matching logic samples incoming cycles and compares them with information stored in trigger registers.

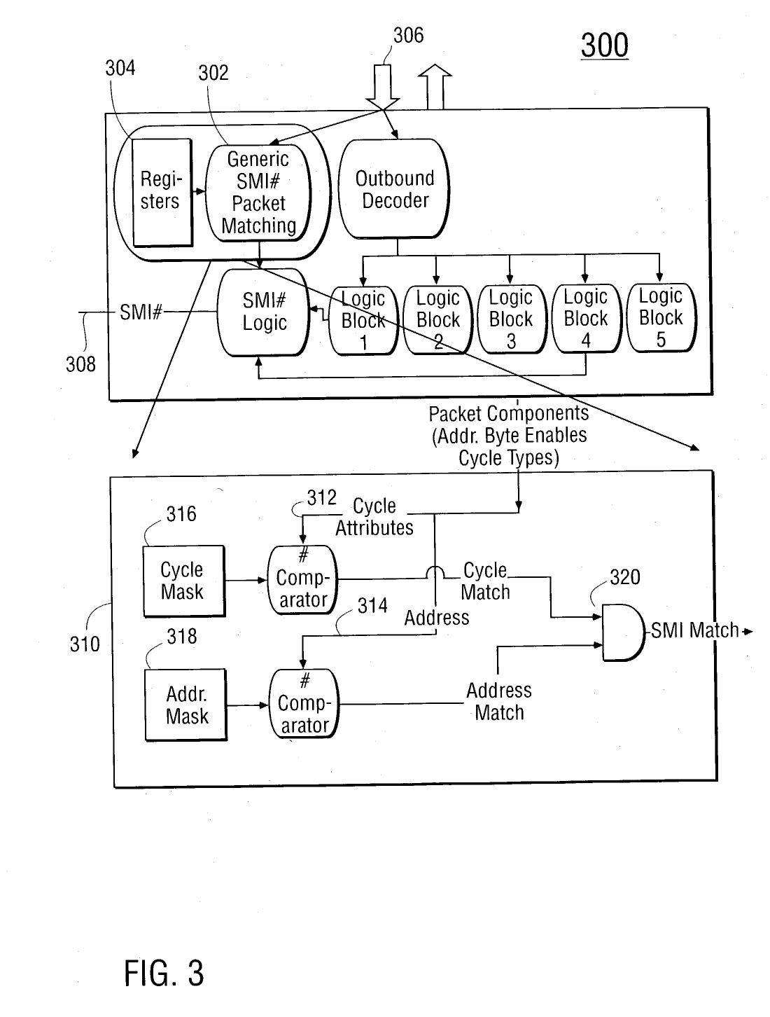

FIG. 3 illustrates a diagram of an embodiment 300 of an implementation of patch device for interrupt (such as SMI) generation. One skilled in the art will recognize that interrupt generation is one of the implementations of the patch device. There are other implementations that may or may not be used concurrently with interrupt generation.

Referring to FIG. 3, interrupt patch device 300 includes interrupt packet matching logic 302 and registers 304 for interrupt generation. Incoming cycles 306 are evaluated and interrupt trigger-matching registers 304 are programmed to detect trigger conditions. An interrupt 308 is generated based upon matching components of a packet-based transaction. The generation of an interrupt enables system specific software to take action based on the presence of the transaction packet elements matching the programmable parameters. When a match is detected, a status bit is set to indicate to software (such as SMM software) that the interrupt cause was the generic cycle match logic matching a transaction.

Interrupt patch device 300 provides programmable capabilities to generate an interrupt 308. An interrupt 308 is generated as the controller receives packet-based transactions, without blocking their progress, rather than after transactions are forwarded past the controller interface. Interrupt generation can also be based on programmable parameters, rather than fixed, non-programmable interrupt generation.

The term “SMI trigger event” as used herein is meant to include a broad range of computer system activities that computer system designers may wish to implement as activities that trigger the execution an SMI. In one implementation, the SMI event includes computer system activities that computer system designers may wish to implement as activities that trigger the execution of a system management interrupt handler routine. One skilled in the art will recognize that the present invention is not limited to identifying any particular type of signal.

In a typical implementation, SMI patch device 300 is used to debug issues in silicon. For example, SMI patch device 300 debugs operating system attempts to go to a power management register in configuration space. Cycle 312 and address 314 information associated with the PCI power management register is programmed into the SMI packet-matching registers 304. In particular, write configuration cycle information including device number, function number, and register offset associated with the PCI power management register are programmed into SMI packet-matching registers 304. Once the SMI packet-matching registers 304 are programmed to detect the SMI trigger condition, incoming cycles 306 are evaluated. The incoming cycle 306 gets directed along the normal path as well as the SMI packet-matching logic 302 where SMI 308 can be generated upon detection of a SMI trigger condition.

As shown in detailed block 310, cycle attributes 312 and address 314 of incoming cycle 306 are compared with the respective information cycle mask 316 and address mask 318. When there is a cycle and address match 320, a SMI trigger condition is detected and signal indicating a SMI match generated, triggering a SMI 308.

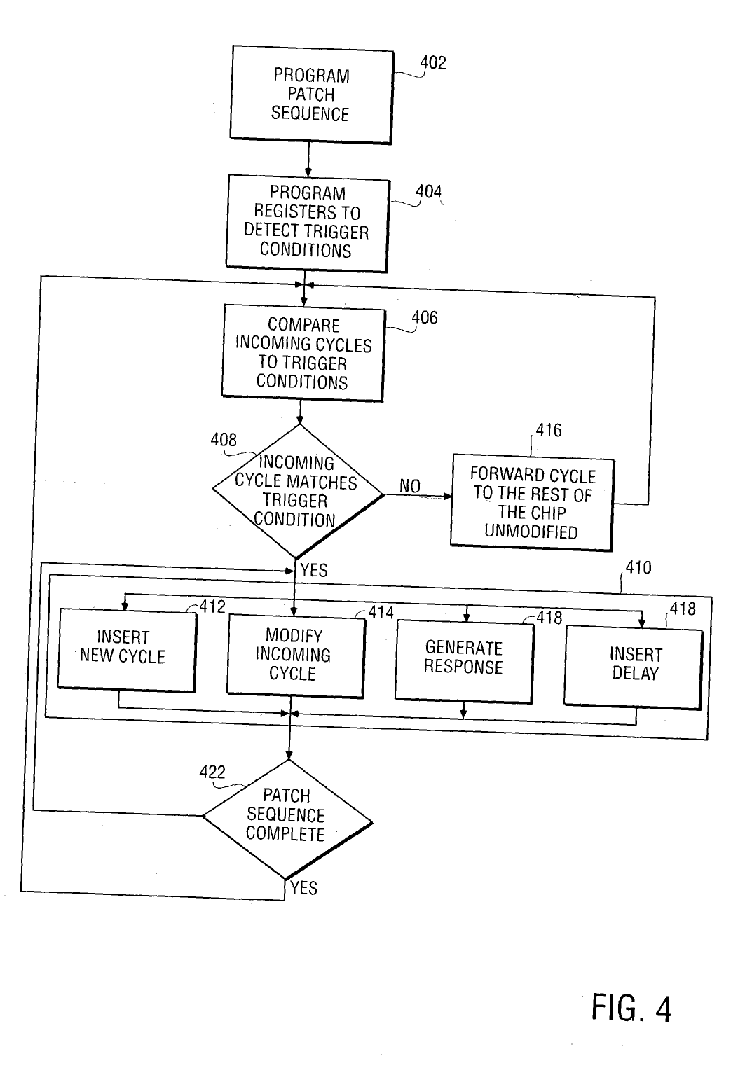

FIG. 4 is a flow diagram of an embodiment 400 of a routine for detecting and altering selected trigger conditions using the patch device.

In step 402, the buffer that holds the patch sequence is programmed by software.

In step 404, registers are programmed to detect trigger conditions.

In step 406, incoming cycles are compared with information stored in trigger registers. Patch device may be implemented with a wide variety of trigger events, including, but not limited to, power management functions and accesses to particular regions of memory. The I/O controller receives the cycles over the memory controller to I/O controller interface. One skilled in the art will recognize that the invention is not limited to the particular implementation. The patch device can be located anywhere on or off the chipset.

In step 408, it is determined whether an incoming cycle matches a desired trigger condition.

In step 410, if the incoming cycle matches a trigger condition, the trigger-matching logic notifies the control unit that determines whether the cycles should be replaced, modified, delayed, or whether an SMI should be generated (or any combination of these items). If the trigger-matching logic indicates that the cycle presented matches a set of trigger register bits, the control logic takes over processing the incoming cycle.

In step 412, alternate cycles stored in FIFO circuit are inserted in place of the cycles that triggered the control logic. The output data is read from patch sequence buffer circuit through the data path when the control signal to multiplexer is enabled. The cycle that triggered the control logic is thus held off from going any further. In a typical implementation, the cycle is potentially causing an error in the system, or there is a desire to work around something the cycle is going to do.

In step 414, the patch device can also modify the incoming cycle that is sampled. For example, if the trigger-matching logic detects an error condition, such as an incorrect address to a register, patch sequence could modify the address associated with the cycle and route it to a different location.

In step 416, incoming cycles that do not cause a trigger are routed on to the rest of the chip. The patch device then returns to compare the next incoming cycle with the trigger conditions.

In step 418, the patch sequence is able to delay the stream of incoming cycles. This may be useful for avoiding failures in which concurrent events are required.

In step 420, the patch sequence asserts a signal, or multiple signals, as part of the response to the trigger. SMI assertion is one such example.

In step 422, the patch device completes execution of one entry in the patch sequence and checks whether there are additional entries in the sequence. If the sequence is not complete, then the next entry is processed and executed. If the sequence is complete, the patch device returns to step 406 to compare incoming cycles to trigger conditions.

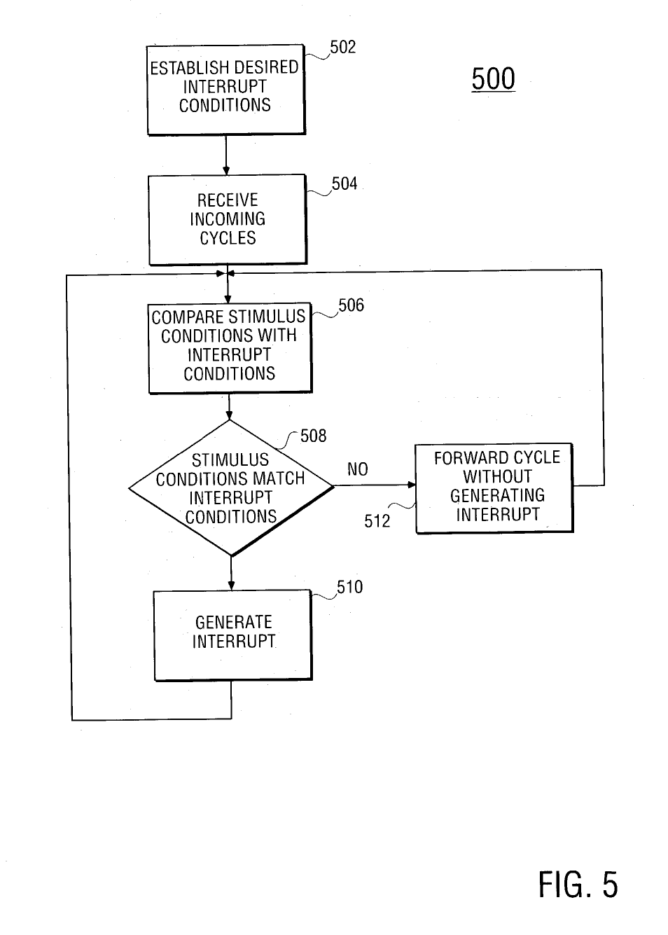

FIG. 5 is a flow diagram of an embodiment of a routine for generating interrupts. In step 502, desired interrupt conditions are established.

In step 504, incoming cycles are received.

In step 506, stimulus conditions associated with the incoming cycles are compared with interrupt conditions in the interrupt matching registers.

In step 508, it is determined whether the stimulus condition matches interrupt conditions.

In step 510, if the stimulus condition matches interrupt conditions, an interrupt is generated (step 510). An interrupt is generated based upon matching components of a packet-based transaction. The generation of an interrupt enables system specific software to take action based on the presence of the transaction packet elements matching the programmable parameters. In a typical implementation, when a match is detected, a status bit is set to indicate to software (such as SMM software) that the interrupt cause was the generic cycle match logic matching a transaction.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus comprising:
an interrupt stimulus matching circuitry, including interrupt matching registers, to receive incoming cycles, wherein the interrupt stimulus matching circuitry detects stimulus conditions associated with the incoming cycles that match desired interrupt conditions; and
a control device to generate an interrupt in response to a stimulus condition matching an interrupt stimulus condition.

2. The apparatus claimed in claim 1, wherein the interrupt stimulus matching registers store interrupt stimulus conditions.

3. The apparatus claimed in claim 2, wherein the interrupt stimulus matching registers are programmable.

4. The apparatus claimed in claim 1, wherein the interrupt comprises a system management interrupt (SMI).

5. The apparatus claimed in claim 1, wherein cycle attributes, addresses, or data are programmed into the interrupt stimulus matching registers.

6. The apparatus claimed in claim 1, wherein cycle attributes, addresses, or data associated with the incoming cycle are compared with desired interrupt stimulus matching conditions.

7. A method for generating interrupts, comprising:
establishing desired interrupt conditions;
receiving incoming cycles;
detecting stimulus conditions associated with the incoming cycles that match desired interrupt conditions; and
generating interrupts in response to stimulus conditions associated with the incoming cycles that match desired interrupt conditions.

8. The method claimed in claim 7, wherein detecting stimulus conditions associated with the incoming cycles that match desired interrupt conditions
comparing the stimulus conditions with interrupt conditions in interrupt matching registers.

9. The method claimed in claim 7, wherein generating interrupts in response to stimulus conditions associated with the incoming cycles that match desired interrupt conditions further comprises:
generating system management interrupts (SMIs) in response to stimulus conditions associated with the incoming cycles that match desired interrupt conditions.

10. The method claimed in claim 7, wherein generating interrupts in response to stimulus conditions associated with the incoming cycles that match desired interrupt conditions further comprises:
comparing cycle attributes, addresses or data associated with the incoming cycle with desired interrupt conditions.

11. An apparatus comprising:
first circuitry to monitor interrupt interrupting activities; and
second circuitry to generate interrupts in response to stimulus conditions associated with the incoming cycles that match desired interrupt conditions.

12. The apparatus claimed in claim 11, wherein the first circuitry to monitor interrupt interrupting activities further comprises:
registers for storing interrupt monitoring parameters.

13. The apparatus claimed in claim 12, wherein the registers are programmable.

14. The apparatus claimed in claim 11, wherein the first circuit generates a system management interrupt (SMI) when a interrupt matching condition is detected.

15. The apparatus claimed in claim 12, wherein the cycle attributes, addresses, or data associated with the incoming cycle are compared with information programmed in the registers.

16. A machine readable medium having stored therein a plurality of machine readable instructions executable by a processor to generate interrupts, comprising:
instructions to establish desired interrupt conditions;
instructions to receive incoming cycles;
instructions to detect stimulus conditions associated with the incoming cycles that match desired interrupt conditions; and
instructions to generate interrupts in response to stimulus conditions associated with the incoming cycles that match desired interrupt conditions.

17. The machine readable medium claimed in claim 16, wherein instructions to detect stimulus conditions associated with the incoming cycles that match desired interrupt conditions
instructions to compare the stimulus conditions with interrupt conditions in interrupt matching registers.

18. The machine readable medium claimed in claim 16, wherein instructions to generate interrupts in response to stimulus conditions associated with the incoming cycles that match desired interrupt conditions further comprises:
instructions to generate system management interrupts (SMIs) in response to stimulus conditions associated with the incoming cycles that match desired interrupt conditions.

19. The machine readable medium claimed in claim 16, wherein instructions to generate interrupts in response to stimulus conditions associated with the incoming cycles that match desired interrupt conditions further comprises:
instructions to compare cycle attributes, addresses or data associated with the incoming cycle with desired interrupt conditions.

20. A system comprising:
a chipset comprising:
an interrupt stimulus matching circuitry, including interrupt matching registers, to receive incoming cycles, wherein the interrupt stimulus matching circuitry detects stimulus conditions associated with the incoming cycles that match desired interrupt conditions; and
a control device to generate an interrupt in response to a stimulus condition matching an interrupt stimulus condition.

21. The system claimed in claim 20, wherein the interrupt stimulus matching registers store interrupt stimulus conditions.
